(19) United States
(12) Patent Application Publication
(10) Pub. No.: US 2006/0072244 A1
(43) Pub. Date: Apr. 6, 2006

(54) Methods for modifying or building a disk drive such that a substance is introduced into a disk drive enclosure with the intent to protect, to damage, or to destroy the disk drive and disk drive's data

(76) Inventor: Robert James Rapp, San Jose, CA (US)

Correspondence Address: ROBERT JAMES RAPP, 1120 RANCHERO WAY #10, SAN JOSE, CA, 95117, US

(21) Appl. No.: 11/242,332

(22) Filed: Oct. 1, 2005

Related U.S. Application Data
(60) Provisional application No. 60/616,285, filed on Oct. 6, 2004.

(51) Int. Cl. G11B 15/10

(52) U.S. Cl. 360/137

(57) ABSTRACT

Data security has two facets, protecting/saving a person's/business's data or destroying data so that it cannot fall into the wrong hands. This invention relates to mechanisms & methodologies for injecting a gas, liquid, solid, chemical, biological agent, nano-technology, or other substance into an existing disk drive for the purpose of protecting &/or destroying the disks, heads, and/or enclosure. A dry inert gas will help protect disk drive heads/media and provides a way to extend the disk drives altitude operational characteristics, substances have been developed that can destroy disk media, & other substances may be used that can make data contained on the disk media difficult or impossible. Thus methods for injecting or introducing various substances into the enclosure of a disk drive are a significant aspect of data security.

### CROSS REFERENCE TO RELATED APPLICATIONS

This application claims benefit from Provisional Patent Application No. 60/616,285 Filing Date Oct. 6, 2004 Confirmation # 4605, a Provisional Patent for which this application is a non-provisional Utility Patent follow up by the same inventor: Robert James Rapp, customer # 41400.

### FEDERAL RESEARCH STATEMENT

Not Applicable

### BACKGROUND OF THE INVENTION

Data security, in respect to the data contained within a disk drive takes on two dimensions: keeping the data from being lost/destroyed and destroying the data to prevent it from falling into “the wrong hands”, both are extremely important in the post September 11 world.

Disk drives require a clean environment for their heads and disk media to function optimally. Any contaminant may degrade the performance or make data very difficult to recover. The enclosure of a disk drive is usually filled with very clean air containing atmospheric gasses. Atmospheric gasses contain large amounts of oxygen, hydrogen, and some nitrogen. Oxygen is a highly reactive gas that combines with hydrogen to form water, is the primary element in the process of oxidation. Reactive gasses can also react with contaminants that are sometimes on components used inside the disk drive. It is even possible for contaminants and gasses to react and form crystals or structures on the surface the disks. All of these reactions may limit the lifetime and performance of the disk drive. If however the disk drive is filled with an inert dry gas, or semi-inert dry gas in the case of Nitrogen, the possibility of these chemical reactions occurring is eliminated. Disk Drives typically have a breather filter that equalizes pressure within the enclosure to pressure outside of the disk drive. Once filled with dry nitrogen a disk drive enclosure should be sealed in order to keep the dry nitrogen within the enclosure. This means that the disk drive's breather filter should be sealed once air has been displaced by nitrogen or eliminated from the design of the disk drive entirely. Alternatively the disk drive could be built without a breather filter at all, and sealed after the enclosure is filled with the dry inert gas. Furthermore pressurizing the disk enclosure above atmospheric pressure would enhance the disk drive's high altitude operational characteristics. Disk Drives have altitude limitations because the heads require a gas of a certain density in order to fly. An airplane cannot fly in a vacuum, and a disk drive head cannot fly in a low-pressure environment.

Data is more available and more portable than it has ever been. Vast amounts of critical data are stored every day on small data storage devices. NOTE: most often the storage device is a disk drive; they are the most prevalent form of data storage in 2004. The loss or theft of a single computer or single disk drive represents an enormous threat to data security.

Destroying data for some (the Department of Defense) is just as important as saving data for others (typical consumer/business). Until recently, however the only way to destroy data within a disk drive with 100% confidence that the data could not be recovered was to dismantle the disk drive and physically destroy the recording surfaces (media) by sanding, punching holes, drilling holes, crushing, or through other invasive and expensive techniques. Recently chemical/gas technologies have been developed for destroying the recording surfaces (media) without dismantling the disk drive. Other technologies or formulas for performing similar functions may be developed, given time. Even the injection of a foam (or substance) that hardens would make the data recovery process very difficult or impossible.

Disk drives typically have access holes built into their enclosure that are used during the drive's manufacturing process. These holes are sealed with adhesive covers that form an airtight seal after the drive is assembled. Typically these stickers are made out of plastics such as “Mylar”; a material that can be easily punctured with pointed needle, nozzle, or edge.

This invention relates to methodologies & mechanisms for injecting or introducing a liquid, gaseous, or solid; chemical, biological agent, or nano-technology into a disk drive for the purpose of protecting the disks, heads, and enclosure or for destroying them.

### DESCRIPTION & SUMMARY OF THE INVENTION

Data security has two facets, protecting/saving a person's/business's data or destroying data so that it cannot fall into the wrong hands. This invention relates to mechanisms & methodologies for injecting a gas, liquid, solid, chemical, biological agent, nano-technology, or other substance into an existing disk drive for the purpose of protecting or destroying the disks, heads, and/or enclosure. A dry inert gas will help protect disk drive heads/media and provides a way to extend the disk drives altitude operational characteristics. Recent developments enable new ways of protecting data by destroying a disk drive's storage media, and other substances can make the data recovery process very difficult or impossible. Both of these require a mechanism and/or a process to inject or introduce an appropriate material into the enclosure of a disk drive. Spinning up or turning on of the disk drive may be used to facilitate the distribution of the substance introduced into the enclosure.

Disk drives require a clean environment for their heads and disk media to function optimally. Any contaminant may degrade the performance or make data very difficult to recover. The enclosure of a disk drive is usually filled with very clean air containing atmospheric gasses. Atmospheric gasses contain large amounts of oxygen, hydrogen, and some nitrogen. Oxygen is a highly reactive gas that combines with hydrogen to form water, is the primary element in the process of oxidation. Reactive gasses can also react with contaminants that are sometimes on components used inside the disk drive. It is even possible for contaminants and gasses to react and form crystals or structures on the surface the disks. All of these reactions may limit the lifetime and performance of the disk drive. If however the disk drive is filled with an inert dry gas, or semi-inert dry gas in the case of Nitrogen, the possibility of these chemical reactions occurring is eliminated. Disk Drives typically have a breather filter that equalizes pressure within the enclosure to pressure outside of the disk drive. Once filled with dry nitrogen a disk drive enclosure should be sealed in order to keep the dry nitrogen within the enclosure. This means that the disk drive's breather filter should be sealed once air has been displaced by nitrogen or eliminated from the design of the disk drive entirely. Alternatively the disk drive could be built without a breather filter at all, and sealed after the enclosure is filled with the dry inert gas. Furthermore pressurizing the disk enclosure above atmospheric pressure would enhance the disk drive's high altitude operational characteristics. Disk Drives have altitude limitations because the heads require a gas of a certain density in order to fly. An airplane cannot fly in a vacuum, and a disk drive head cannot fly in a low-pressure environment.

Several ways to build such a mechanism include, yet are not limited to:
1. Bonding a miniature enclosure over a seal. The miniature enclosure is attached to a nozzle, or hose through which the destructive agent may be introduced into the disk drive's enclosure on demand. In this implementation the seal will have to be punctured or removed during the rework process. The miniature enclosure will be designed to provide a seal to the external environment to prevent contaminating the internal disk drive components. The enclosure may be solid or flexible.
2. A needle, nozzle, or hose may be fitted with a seal slightly above its tip. The tip can be used to puncture a pre-existing seal and a new seal may be made during the same operation.
3. Mounting an actuated needle, nozzle, or hose through which a destructive agent may be introduced into the disk drive's enclosure on demand. Upon a trigger the actuator will force the needle (nozzle, or hose) through the seal (or breather filter) such that a destructive agent may be released within the disk drive's enclosure.
4. Packaging a disk drive with seals removed inside of another enclosure with a nozzle entering the outer enclosure. Upon demand a substance may be released within the enclosure.

Furthermore if the purpose is to inject a substance such as an inert gas into the enclosure, certain processes may be used to increase the efficiency of this operation, including:
1. Vacuum out the air from the enclosure through a seal or the breather filter, then inject/introduce the gas into the enclosure to a desired pressure. The breather filter may be sealed with another seal before or after this process. If a seal were used to vacuum the air out, sealing up the breather filter prior to the operation would be preferred.
2. Inject the inert gas into the enclosure while venting air out of the breather filter or seal. Note: inert gasses have different densities than components in air. Helium for example is lighter than air and will rise, as air is pressed downward. Here the air is displaced out of the bottom of the disk drive as helium is introduced into the top, because differences in the densities of the substances.
3. Build the drive in a dry nitrogen environment.
4. Build the drive without a breather filter.

### BRIEF DESCRIPTION OF THE DRAWINGS

FIG. 1 shows a disk drive (top view 1A, side view 1B) with an enclosure (top view 2A, side view 2B) bonded over a hole (3) in the disk drive's enclosure. A nozzle with hose attached will be used to inject a substance into the drive's enclosure.

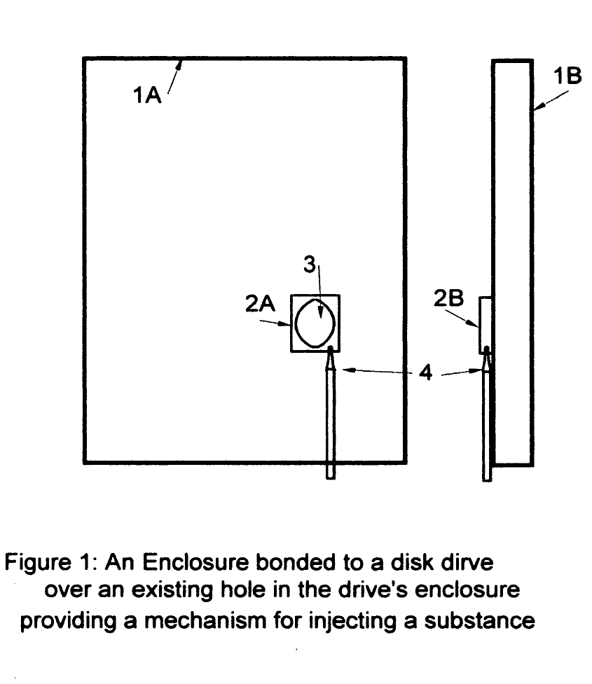

FIG. 2 shows a disk drive (5A, 5B), a seal covering a hole in the disk drive enclosure (6A, 6B), a new seal (7A, 7B) attached to a nozzle and hose (8A, 8B). Before the nozzle, hose, and the new seal are attached to the disk drive are shown (5A, 6A, 7A, & 8A).

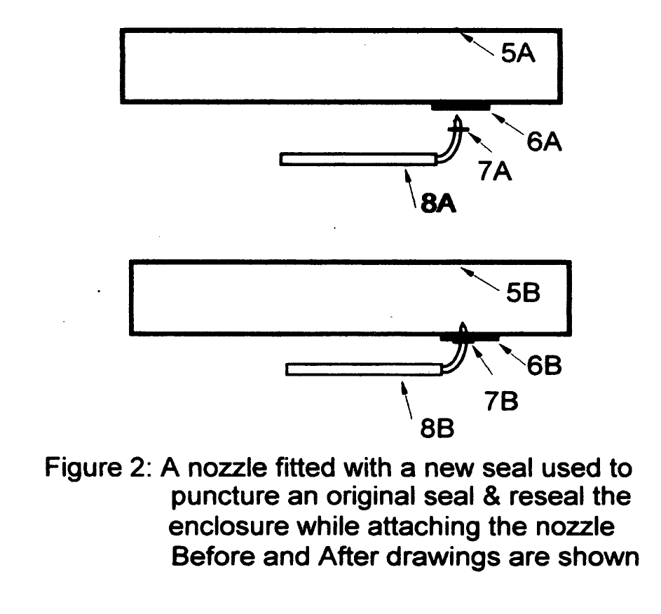

After the nozzle, hose, and the new seal are attached are also depicted (5V, 6B, 7B, & 8B). Here the sharp nozzle punctures the original seal and the new seal forms a new airtight seal.

FIG. 3 shows a disk drive (9A, 9B), a seal covering a hole in the disk drive enclosure (10A, 10B), a nozzle an hose (11A, 11B), and an actuator (12A, 12B). The system before the nozzle punctures the seal is shown (9A, 10A, 11A, & 12A). The system after the actuator forces the nozzle through the hole is also shown (9B, 10B, 11B, & 12B).

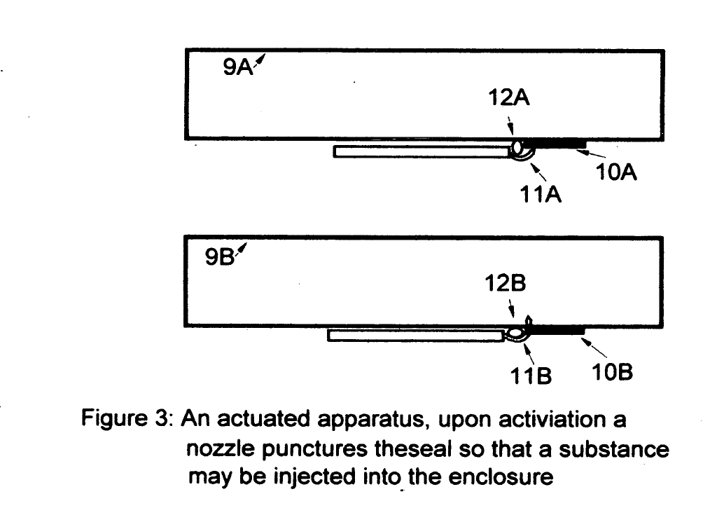

FIG. 4 shows a disk drive (top view 13A, side view 13B) packaged within another enclosure (top view 14A, side view 14B). A nozzle and hose are also depicted (top view 15A, side view 15B).

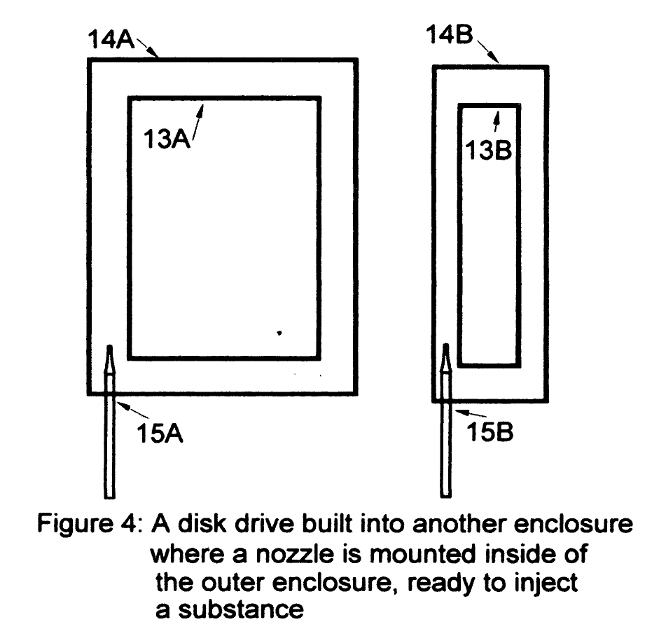

FIG. 5 shows a disk drive enclosure (top view 16A, side view 16B) a vacuum mechanism, with hose (top view 17A, side view 17B) and injection mechanism, with hose (top view 18A, side view 18B) are shown. Vacuum and injection mechanisms are shown with integrated sealing mechanisms.

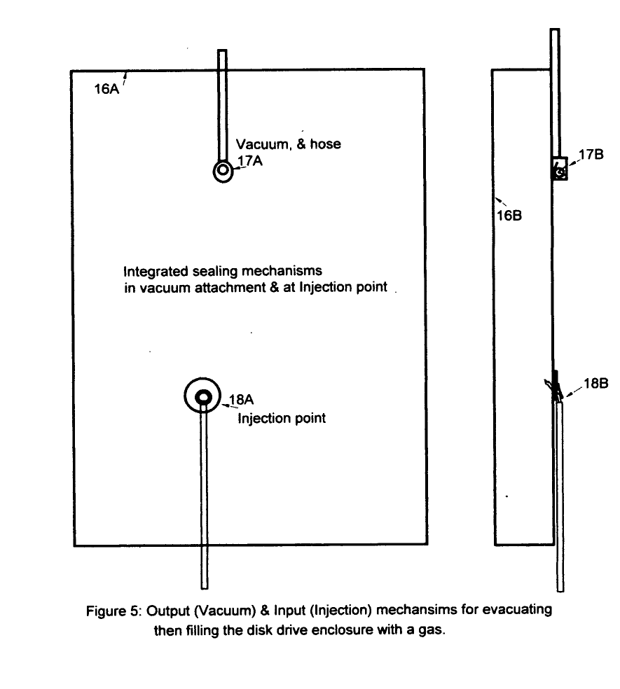

1. An apparatus that is designed to introduce a substance into the enclosure of a disk drive.

2. Claim 1 where the substance is intended to destroy the disk drive's data/media.

3. Claim 1 where the substance is intended to protect the disk drive's data/media.

4. Claim 1 where the gas within the enclosure (air or other) is displaced such that a substance (inert gas or other) may be introduced into the enclosure more efficiently.

5. Claim 4 where the gas (air or other) within the enclosure is displaced by a vacuum.

6. Claim 1 where a disk drive enclosure is fabricated with one or more access port(s) through which a substance may be injected or introduced into the disk drive enclosure.

7. Claim 3 where the substance is a dry inert gas.

8. Claim 7 where part of the apparatus includes a sharp edge, needle, or nozzle, that when activated presses through & punctures an element covering one or more covered holes in the disk drive enclosure, including holes covered by a breather filter or filters, and where the puncture or punctures, holes, and breather filters are subsequently sealed trapping the inert gas inside the disk drive enclosure.

9. Claim 3 where the disk drive is placed within another enclosure.

10. Claim 9 where substances are introduced into both inner and outer enclosures.

11. Claim 2 where part of the apparatus a sharp edge, needle, or nozzle, that when activated presses through & punctures an element covering one or more covered holes in the disk drive enclosure, including holes covered by a breather filter or filters.

12. Claim 2 where a portion, part or whole of the apparatus is bonded over a portion of the disk drive, part or whole such that one or more holes, including holes covered by breather filters, in the disk drive enclosure are covered by another enclosure, this includes packaging the entire disk drive within another enclosure.

13. A method for introducing a substance into the enclosure of a disk drive.

14. Claim 13 where the substance introduced into the enclosure is a dry inert gas & where the process seals the enclosure trapping the gas inside the disk drive enclosure, this includes covering or sealing the disk drive's breather filter.

15. Claim 14 where the drive is manufactured in an environment of a dry inert gas, such that the dry inert gas enters the enclosure that will subsequently be sealed, the drive may be built without a breather filter or with a covered breather filter.

16. Claim 14 where the process pressurizes the environment within the disk drive enclosure above ambient pressure.

17. Claim 2 with the additional facility of spinning up the disk drive is used to distribute the substance across all surfaces.

18. Claim 17 where a power source, separate or built in, battery or other is utilized to keep the disk drive rotating while introducing the substance.

19. Claim 10 where the process is controlled and implemented electronically.

20. Claim 10 where the process is controlled remotely.

21. Claim 10 the process is controlled automatically, and limits the geographic travel of the disk drive.
